(19) United States
(12) Patent Application Publication
(10) Pub. No.: US 2015/0029091 A1
(43) Pub. Date: Jan. 29, 2015

(54) INFORMATION PRESENTATION APPARATUS AND INFORMATION PROCESSING SYSTEM

(71) Applicant: Sony Corporation, Tokyo (JP)

(72) Inventors: Yusaku Nakashima, Tokyo (JP); Yukifumi Iwakuma, Tokyo (JP)

(73) Assignee: Sony Corporation, Tokyo (JP)

(21) Appl. No.: 14/337,298

(22) Filed: Jul. 22, 2014

(30) Foreign Application Priority Data
Jul. 29, 2013 (JP) 2013-156435

(51) Int. Cl. G06F 3/01; G02B 27/01

(52) U.S. Cl. CPC G06F 3/012; G06F 3/016; G02B 27/0179; G02B 27/0172; G02B 2027/0187
USPC 345/156

(57) ABSTRACT

An information presentation apparatus includes a main body, a detection unit, and a presentation unit. The main body is mounted on a head portion of a user. The detection unit is disposed on a position intersecting a median plane of the user who wears the main body and configured to detect a motion of the head portion of the user. The presentation unit is disposed on the main body and is capable of presenting information switched on the basis of an output from the detection unit to the user.

### CROSS REFERENCE TO RELATED APPLICATIONS

This application claims the benefit of Japanese Priority Patent Application JP 2013-156435 filed Jul. 29, 2013, the entire contents of which are incorporated herein by reference.

### BACKGROUND

The present technology relates to a head-mounted information presentation apparatus and an information processing system.

A head-mounted information presentation apparatus such as a head-mounted display (HMD) is known (see, Japanese Patent Application Laid-open No. 2011-145488 and http://www.sony.jp/hmd/products/HMZ-T1/). Such an information presentation apparatus has excellent portability and is capable of presenting information for a user regardless of location and switching information presented as necessary by a user's input operation. Further, the HMD is capable of displaying a realistic 3D image with depth added, and is used to provide an endoscopic image at a time of an endoscopic surgery, for example.

On the other hand, in the HMD, when an input operation is performed with a hand or the like, a problem arises in some cases. For example, in the case where a main body mounted on a head portion is provided with an input unit, it is difficult to operate while confirming an input button and the like. Therefore, there is a fear that an operation error may be caused. Further, as in the case where an endoscopic surgery is performed, an operation with a hand is difficult to be performed for hygienic reasons. In view of this, the structure in which an input operation is performed by a motion of a user who wears the HMD is being studied.

### SUMMARY

However, when an operation of switching an image, sound, or the like is tried to be performed by a motion of a user, it is necessary to correctly determine whether a predetermined motion is performed or not. Therefore, a motion of a user has to be detected with high accuracy.

However, it is difficult to correctly grasp a motion of a head portion by using a motion sensor such as an angular velocity sensor

In view of the circumstances as described above, it is desirable to provide an information presentation apparatus and an information processing system capable of performing an input operation by a motion of a user with higher accuracy.

According to an embodiment of the present disclosure, there is provided an information presentation apparatus including a main body, a detection unit, and a presentation unit.

The main body is mounted on a head portion of a user. The detection unit is disposed on a position intersecting a median plane of the user who wears the main body and configured to detect a motion of the head portion of the user.

The presentation unit is disposed on the main body and capable of presenting information switched on the basis of an output from the detection unit to the user.

The detection unit is disposed on the bilaterally symmetrical position and is moved along the same track as the center of gravity of the head portion. Further, there is less influence or the like of a twist of a neck associated with a pivotal motion. Thus, it is possible to detect the motion of the head portion with high accuracy on the basis of the detection signal from the detection unit.

As a result, on the basis of the motion of the head portion based on user's intention, the information presented by the presentation unit can be switched to desired information.

For example, the detection unit may be disposed to be opposed to a glabella portion of the user who wears the main body in a direction perpendicular to the glabella portion.

As a result, it is possible to dispose the detection unit on the position closer to the center of gravity of the head portion and detect the motion of the head portion with higher accuracy.

The presentation unit may include a display unit capable of displaying an image switched on the basis of the output from the detection unit in front of eyes of the user.

As a result, it is possible to form the information presentation apparatus as a head mount display, for example, and present an image based on user's intention to the user.

Alternatively, the presentation unit may include a speaker unit capable of outputting voice switched on the basis of the output from the detection unit to the user.

As a result, it is possible to present voice based on user's intention to the user.

The detection unit may include an angular velocity sensor unit that detects the motion of the head portion of the user.

As a result, it is possible to detect the motion of the head portion of the user on the basis of an angular velocity generated by the motion of the head portion of the user.

The angular velocity sensor unit may include a first vibration element that detects an angular velocity about a first axis based on a first motion of the user, and a second vibration element that detects an angular velocity about a second axis based on a second motion of the user, the second axis being different from the first axis.

As a result, it is possible to detect a plurality of motions of the user by using a gyro sensor of vibration type.

Further, a direction of the first axis may be one of a lateral direction and a vertical direction.

As a result, it is possible to select a motion which can be easily performed by the user but is not performed unconsciously, such as a motion of shaking the head up and down like nodding and a motion of directing a face rightward and leftward.

The direction of the first axis and a direction of the second axis may be perpendicular to each other.

As a result, it is possible to suppress crosstalk between the first and second vibration elements and further reduce a noise of the detection signal.

Further, the first and second vibration elements each may have a first end portion capable of vibrating and a second end portion opposite to the first end portion and be extended along the directions of the first and second axes, respectively, and in the angular velocity sensor unit, a distance from a point at which a first straight line and a second straight line intersect to the second end portion of the first vibration element may be equal to a distance from the point to the second end portion of the second vibration element, the first straight line being extended along the direction of the first axis from the first vibration element, the second straight line being extended along the direction of the second axis from the second vibration element.

As a result, it is possible to suppress a deviation between detection sensitivities of the first and second vibration elements and increase the detection accuracy for the motion of the head portion.

Further, the angular velocity sensor unit may include a detection body capable of detecting angular velocities about three axes different from one another.

As a result, it is possible to make the structure of the angular velocity sensor unit compact and dispose the unit in a small space. Thus, it is possible to easily dispose the detection unit on the desired position intersecting the median plane of the user.

According to another embodiment of the present disclosure, there is provided an information processing system including a main body, a presentation unit, a detection unit, and a control unit.

The main body is mounted on a head portion of a user.

The presentation unit is disposed on the main body and capable of presenting predetermined information to the user.

The detection unit is disposed on a position intersecting a median plane of the user who wears the main body and configured to detect a motion of the head portion of the user.

The control unit is configured to switch the information presented by the presentation unit on the basis of an output from the detection unit.

As described above, according to the present technology, it is possible to provide the information presentation apparatus and the information processing system capable of performing the input operation with higher accuracy on the basis of the motion of the user. These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a schematic diagram showing the structure of an information processing system according to a first embodiment of the present technology;

FIG. 2 is a block diagram showing the structure of the information processing system;

FIG. 3 is a cross-sectional view showing a form in which a head-mounted display (HMD) shown in FIG. 1 is provided on a user when viewed from X-axis direction;

FIG. 4 is a perspective view of the HMD when viewed from a direction of facing a display surface of the HMD;

FIG. 5 is a block diagram showing the structure of a presentation unit (display unit) shown in FIG. 2;

FIGS. 6A and 6B are plan views (front surface views) for explaining the disposition of a detection unit shown in FIG. 1, in which FIG. 6A shows a head portion of a user, and FIG. 6B shows the disposition of the detection unit on the HMD;

FIG. 7 is a schematic diagram showing the structure of the detection unit;

FIG. 8 is a flowchart for explaining an operation example of a controller (control unit) shown in FIG. 2;

FIG. 9 is a graph showing a specific example of a detection signal at a time when the detection unit is disposed on a point A of FIG. 12, in which a lateral axis represents time, and a vertical axis represents a voltage value;

FIG. 10 is a graph showing a specific example of a detection signal at a time when the detection unit is disposed on a point B of FIG. 12, in which a lateral axis represents time, and a vertical axis represents a voltage value;

FIG. 11 is a graph showing a specific example of a detection signal at a time when the detection unit is disposed on a point C of FIG. 12, in which a lateral axis represents time, and a vertical axis represents a voltage value;

FIG. 12 is a schematic perspective view of the HMD showing the dispositions of the detection unit corresponding to FIGS. 9 to 11;

FIGS. 13A and 13B are schematic diagrams for explaining a relationship between a second motion of the user and the dispositions of the detection unit, in which

FIG. 13A shows the case where the detection unit is disposed on the point A of FIG. 12, and FIG. 13B shows the case where the detection unit is disposed on the point C of FIG. 12;

FIG. 14 is a schematic diagram showing distances r1, r2, and r3 from a neck, which is regarded as the center of rotation of the head portion, to the point A, the point B, and the point C, respectively;

FIG. 15 is a block diagram showing the structure of an information processing system according to a second embodiment of the present technology; and

FIG. 16 is a block diagram showing the structure of an information processing system according to a third embodiment of the present technology.

### DETAILED DESCRIPTION OF EMBODIMENTS

Hereinafter, embodiments of the present disclosure will be described with reference to the drawings.

### First Embodiment

### Information Processing System

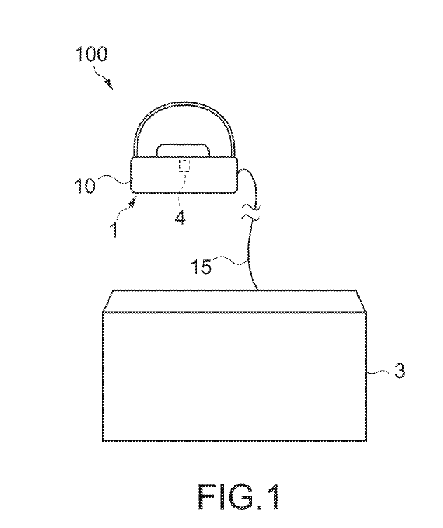

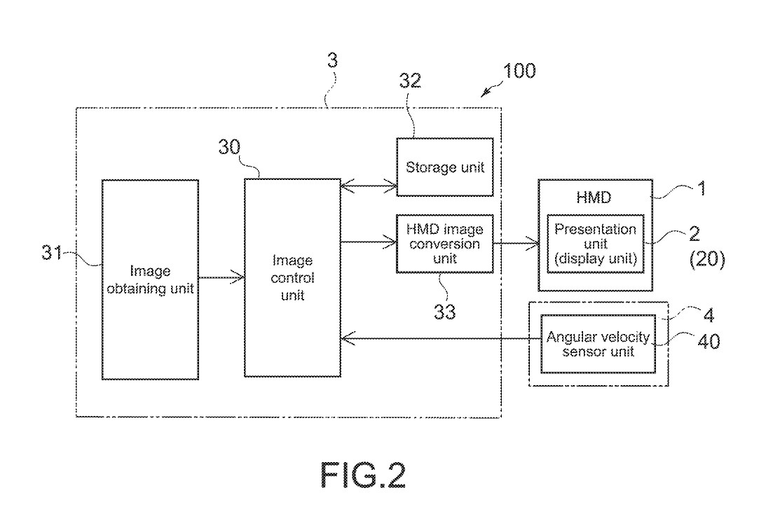

FIG. 1 and FIG. 2 are diagrams for explaining an information processing system according to an embodiment of the present technology. FIG. 1 is a schematic diagram showing the structure of the information processing system, and FIG. 2 is block diagram showing the structure of the information processing system.

An information processing system 100 according to this embodiment includes a main body 10, a detection unit 4, a presentation unit 2, and a controller (control unit) 3. In this embodiment, the main body 10, the detection unit 4, and the presentation unit 2 are provided to a head-mounted display (HMD) 1. The HMD 1 functions as an “information presentation apparatus” according to this embodiment.

The information processing system 100 according to this embodiment is capable of switching images presented by the HMD 1 by a motion of a user who wears the HMD 1. Such an information processing system 100 can be used as a surgery assistant system in an endoscopic surgery as an example. In this case, a medical professional (user) who performs surgery operations wears the HMD 1 and can carry out the surgery operation. Alternatively, the information processing system 100 can be used for various purposes such as providing games and providing movies through the HMD 1.

The HMD 1 is connected with the controller 3 via a cable 15, for example. To the controller 3, predetermined image data is input, and images presented from the HMD 1 can be switched on the basis of a motion of a user.

The HMD 1 includes the main body 10 mounted on a head portion of a user, the presentation unit 2 capable of presenting predetermined information to a user, and the detection unit 4. Image data presented by the HMD 1 is not particularly limited. For example, the information processing system 100 is used at a time of an endoscopic surgery, an endoscopic image, an ultrasonic image, or the like can be applied. Alternatively, in accordance with a use form of the information processing system 100, a game image, a movie, or different various image data can be applied. Hereinafter, the structure of the HMD 1 will be described.

(HMD)

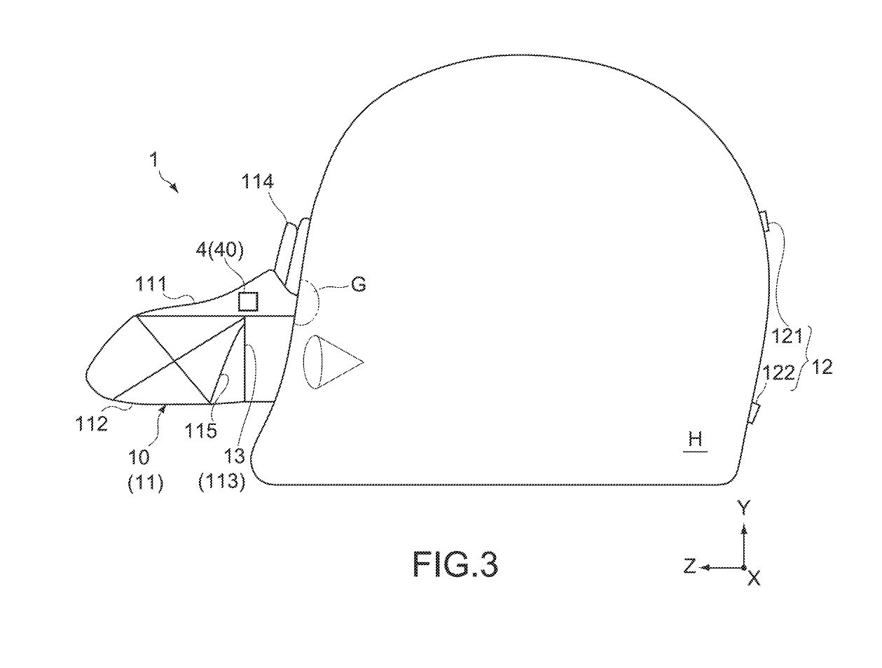

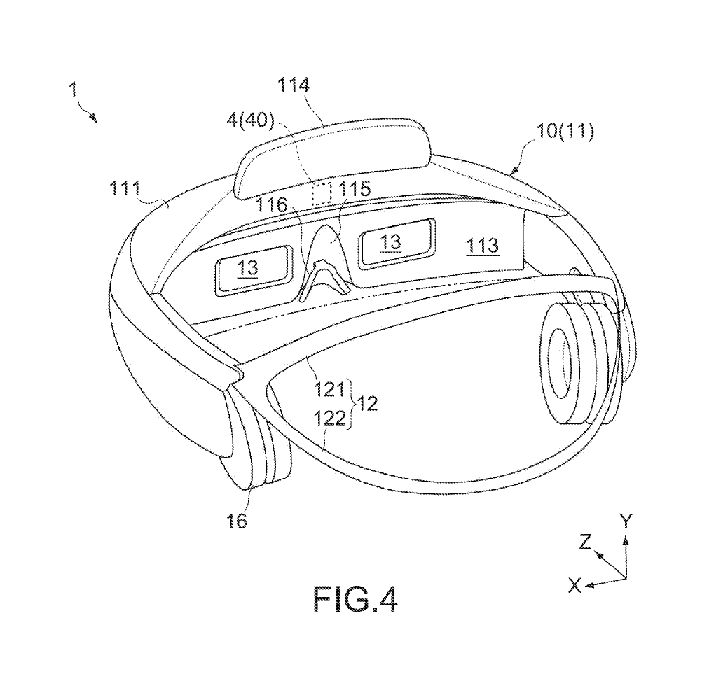

FIGS. 3 and 4 are diagrams showing the structure of the HMD according to this embodiment. FIG. 3 is a cross-sectional view thereof showing a state of being mounted on a user when viewed in an X-axis direction. FIG. 4 is a perspective view thereof when viewed in a direction of facing a display surface. It should be noted that in FIG. 3, H represents a user.

It should be noted that the X-axis direction, a Y-axis direction, and a Z-axis direction in the figures represent three-axis directions orthogonal to one another in an XYZ coordinate system to which a user belongs. The X-axis direction and the Z-axis direction indicate a horizontal direction, and the Y-axis direction indicates a vertical direction (up and down direction). Further, in a basic posture, the X-axis direction is set as a right-and-left direction of the HMD 1 and a user, the Y-axis direction is set as a vertical direction of the HMD 1 and a user, and the Z-axis direction is set as a front-back (front surface to back surface) direction of the HMD 1 and of a user. It should be noted that the “basic posture” refers to a state in which a user wears the HMD 1 in an upright posture at rest without a motion of a head portion to be described later.

The HMD 1 according to this embodiment is formed as a goggle-shaped, non-transmission type HMD as an entire form, for example. Further, as described above, the HMD 1 includes the main body 10, the presentation unit 2, and the detection unit 4. Hereinafter, the elements of the HMD 1 will be described.

(Main Body)

The main body 10 is mounted on a head portion of a user and is provided with a casing 11 and display surfaces 13 for a left eye and a right eye. In this embodiment, the main body 10 is formed to be bilaterally symmetrical. Further, the display surfaces 13 according to this embodiment have the same structure for the left eye and the right eye, and thus denoted by the same reference numeral.

The casing 11 can be disposed in front of user's eyes and is fitted to a user's face. The casing 11 includes an upper surface 111 and a lower surface 112 and has a semi-disc shape swelled in the Z-axis direction entirely, for example. On the upper surface 111, a pad portion 114 which is in contact with a forehead of the user when mounted and is configured to fix a mounted position of the casing 11 may be disposed. Further, to right and left side surfaces of the casing 11, a mount portion 12 to be described later is connected, and headphones 16 may be provided thereto, respectively.

In addition, the casing 11 is opposed to the face of the user including the right and left eyes at a predetermined interval in the Z-axis direction and includes an eyepiece surface 113 which is approximately perpendicular to the Z-axis direction. The eyepiece surface 113 is continuously connected with the lower surface 112 on a lower end thereof. Further, at the center portion of the eyepiece surface 113, for example, a cutout 115 is formed so as to fit to the shape of a user's nose. Further, to the cut out 115, a nose rest 116 detachably attached may be provided, for example. It should be noted that FIG. 3 shows the state in which the nose rest 116 is detached.

The display surfaces 13 are supported by the casing 11 and present images to the user. That is, the display surfaces 13 can present images for the left eye and the right eye processed by the controller 3 with respect to the left eye and the right eye of the user, respectively.

In the casing 11, in this embodiment, the detection unit 4 is disposed so as to face a glabella portion G of the user in a direction perpendicular to the Z-axis direction. The detection unit 4 will be described later in detail.

The main body 10 further includes the mount portion 12 capable of mounting the casing 11 on an appropriate relative position. The structure of the mount portion 12 is not particularly limited, but for example, the mount portion 12 includes an upper band 121 and a lower band 122 fitted to an occipital portion of the user and connected to the casing 11. The upper band 121 and the lower band 122 may be made of a flexible material such as nylon and polypropylene, a material having stretching properties such as silicone rubber and elastomer, or the like as appropriate. Further, the upper band 121 and the lower band 122 may be integrally formed or may have variable lengths.

(Presentation Unit)

The presentation unit 2 is disposed in the casing 11 of the main body 10 and is capable of presenting information switched on the basis of an output from the detection unit 4 to the user. In this embodiment, the presentation unit 2 includes a display unit 20 capable of displaying the image switched on the basis of the output from the detection unit 4 in front of the eyes of the user. Hereinafter, the display unit 20 will be described.

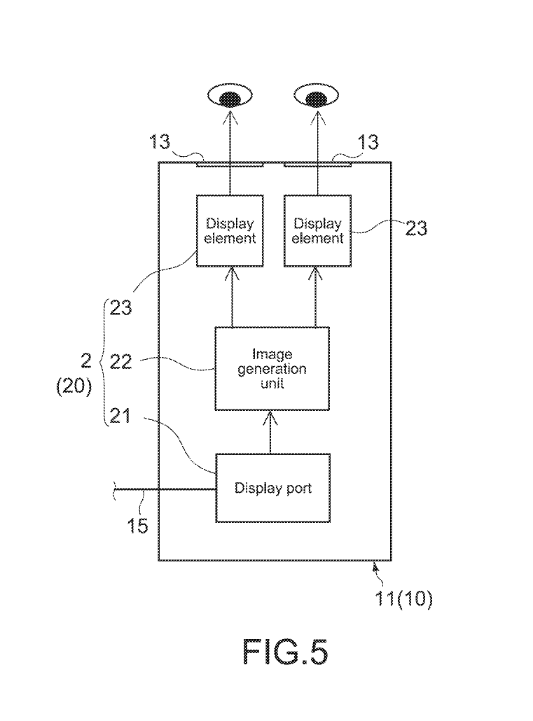

FIG. 5 is a block diagram showing the structure of the presentation unit 2 (display unit 20). The display unit 20 includes a display port input terminal 21, an image generation unit 22, and a display elements 23. The display port input terminal 21 is connected with the controller 3 via the cable 15, for example, and obtains an image control signal as image data. The image generation unit 22 generates an image signal to be output to each of right and left display elements 23 on the basis of the image control signal. Then, the display elements 23 emit image light corresponding to those image signals to the display surfaces 13, respectively, and thus an image is displayed to the user. It should be noted that the display elements 23 for the left eye and the right eye have the same structure as in the case of the display surfaces 13 and are thus denoted by the same reference numerals.

Specifically, the image generation unit 22 may perform a predetermined shifting process or the like with respect to the image control signal to generate image signals for the left eye and the right eye appropriate to the HMD 1. As a result, it is possible to present a 3D image to the user. A shift amount in the shifting process is calculated from a distance between the display elements 23 of the HMD 1 and the eyes, a distance between the eyes, a virtual image position to be described later, or the like.

On the basis of the image signal input from the image generation unit 22, the left and right display elements 23 emits image light toward the left and right display surfaces 13. In this embodiment, the display elements 23 are formed of organic EL (Electroluminescence) elements. By using the organic EL elements as the display elements 23, it is possible to achieve compactness, high contrast, rapid responsiveness, and the like.

The display element 23 has the structure in which a plurality of red organic EL elements, green organic EL elements, blue organic EL elements, and the like are arranged in a matrix pattern, for example. Those elements are driven by an active-matrix drive circuit, a passive matrix drive circuit, or the like, thereby performing self-emission at predetermined timing, brightness, and the like, respectively. Further, the drive circuits are controlled on the basis of the image signal generated by the image generation unit 22, with the result that a predetermined image is displayed on the display elements 23 as a whole.

It should be noted that the structure of the display elements 23 is not limited to the above. For example, a liquid crystal display element (LCD) or the like can be used.

Between the display elements 23 and the display surfaces 13, as an optical system, for example, a plurality of eyepieces (not shown). By causing the eyepieces and the user's eyes to be opposed with a predetermined distance, it is possible to cause the user to observe a virtual image which seems to be displayed on a predetermined position (virtual image position). The virtual image position and a size of the virtual image are set by the structures or the like of the display elements 23 and the optical system. For example, the size of the virtual image is a movie theater size of 750 inch, and the virtual image position is set to approximately 20 m distanced from the user. Further, to cause the virtual image to be observed, the casing 11 is disposed on an appropriate position relative to the user in such a manner that the image light emitted from the display elements 23 with the Z-axis direction as an optical axis direction is focused on retinas of the left and right eyes by the eyepieces or the like.

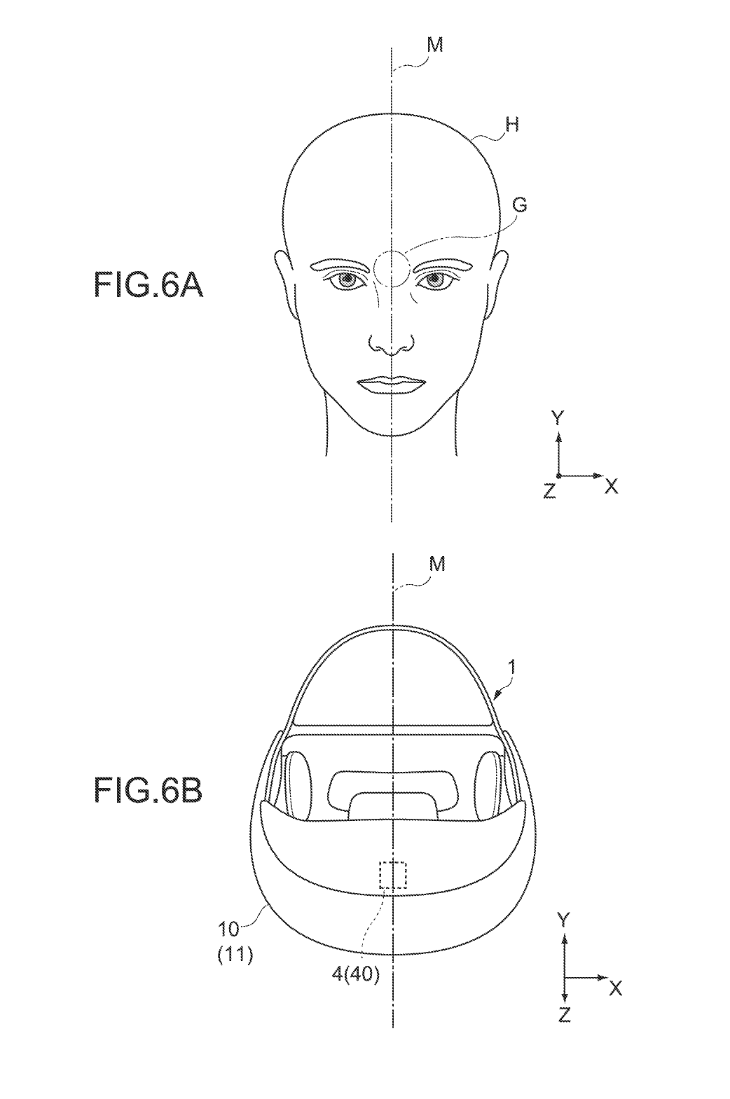

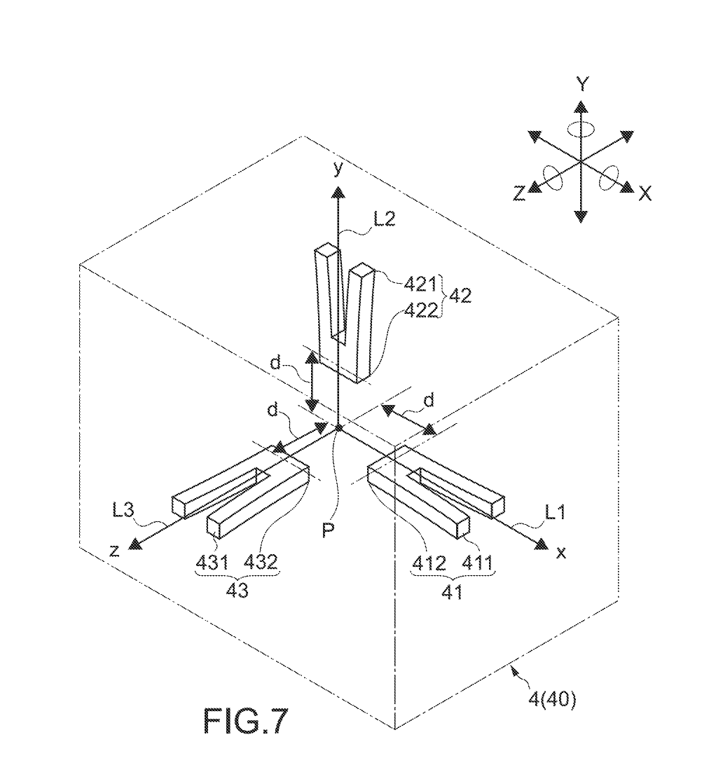

(Detection unit) FIG. 6 are a plan view (front view) for explaining the disposition of the detection unit. FIG. 6A shows the head portion of the user, and FIG. 6B shows the disposition of the detection unit on the HMD (main body). FIG. 7 is a schematic diagram showing the structure of the detection unit 4.

The detection unit 4 is disposed on a position intersecting a median plane M of a user H who wears the main body 10 so as to be capable of detecting a motion of the head portion of the user H. Here, the “median plane” refers to a plane that forms the center on the bisymmetrical head portion of the user. Specifically, the median plane indicates a cross section of the head portion of the user in the vertical direction which is taken along the line that links the center portion of the nose, the glabella portion, the vertex portion, and the occipital portion of the user. In addition, the meaning of “intersecting the median plane” includes a meaning that at least a part of the detection unit 4 only has to be crossed with a plane to which the median plane belongs.

In this embodiment, the detection unit 4 is disposed so as to be opposed to the glabella portion G in a direction perpendicular to the glabella portion G of the user H who wears the main body 10. In addition, the detection unit 4 can be disposed near the eyepiece surface 113 in the casing 11 (see, FIGS. 3 and 4). The “glabella portion” in this case indicates an approximately flat area sandwiched between the left and right eyebrows on the face of the user. Further, “to be opposed in the direction perpendicular to the glabella portion” means being opposed in a direction approximately perpendicular to the flat surface, when the glabella portion is assumed to be the flat surface. In this embodiment, the glabella portion G is assumed to be a plane parallel to an XY plane, and the fact of being opposed to the glabella portion G in the Z-axis direction (see, FIG. 3).

As a result, it is possible to dispose the detection unit 4 relatively near the center of gravity of the head portion, and more correctly grasp the motion of the head portion of the user. Further, it is possible to dispose the detection unit 4 in the casing 11 and suppress a feeling of strangeness at the time of mounting with the degree of freedom of the design of the HMD 1 maintained.

The detection unit 4 includes an angular velocity sensor unit 40 that detects the motion of the head portion of the user. That is, in this embodiment, the angular velocity sensor unit 40 is formed as an angular velocity sensor module that detects an angular velocity around the three axes orthogonal to one another.

The angular velocity sensor unit 40 includes a first vibration element 41, a second vibration element 42, and a third vibration element 43. The first vibration element 41 detects an angular velocity around an x axis (first axis) based on a first motion of the user. The second vibration element 42 detects an angular velocity around a y axis (second axis) based on a second motion of the user. The third vibration element 43 detects an angular velocity around a z axis (third axis) based on a third motion of the user.

In this embodiment, the angular velocity sensor unit 40 is disposed on the main body 10 so that, in a basic posture of the user, an x-axis direction coincides with the X-axis direction, a y-axis direction coincides with the Y-axis direction, and a z-axis direction coincides with the Z-axis direction. At this time, the x-axis direction is set to a right-and-left direction, the y-axis direction is set to a vertical direction, and the z-axis direction is set as the front-back direction. Further, the x-axis direction, the y-axis direction, and the z-axis direction are three-axis directions orthogonal to one another. As a result, motions of components around the x axis, the y axis, and the z axis can be detected with high accuracy, and crosstalk (axis interference) among axes can be suppressed.

Further, the first to third motions are not particularly limited, but motions corresponding to intuition of the user can be applied thereto. For example, as the first motion, a motion of rotating the head around the X axis can be adopted. For example, a motion of shaking the head up and down like nodding can be set. Further, as the second motion, a motion of rotating the head around the Y axis can be adopted. For example, a motion of directing the face rightward and leftward can be set. Further, as the third motion, a motion of rotating the head around the Z axis can be adopted. For example, a motion of tilting the head to a right side and a left side like cocking the head to the side can be set.

In this embodiment, the first, second, and third vibration elements 41, 42, and 43 are formed as gyro sensors of vibration type. The first, second, and third vibration elements 41, 42, and 43 may be provided in the same package or in different packages. Further, out of those vibration elements 41, 42, and 43, two vibration elements may be provided in the same package, and the other vibration element may be provided in a different package.

The first, second, and third vibration elements 41, 42, and 43 have first end portions 411, 421, and 431 capable of vibrating and second end portions 412, 422, and 432 on the opposite side of the first end portions 411, 421, and 431, respectively, and are extended in the x-axis, y-axis and z-axis directions, respectively.

In this embodiment, the first, second, and third vibration elements 41, 42, and 43 can be formed as tuning fork vibration elements and each have two arms opposed to each other in a direction perpendicular to a detection axis, for example. It should be noted that the first, second, and third vibration elements 41, 42, and 43 are not limited to the tuning fork type, but may be a cantilever type, for example. It should be noted that in the following description, the “detection axis” refers to an axis with which each of the vibration elements can detect the angular velocity. For example, the detection axis of the first vibration element 41 is the x axis, the detection axis of the second vibration element 42 is the y axis, and the detection axis of the third vibration element 43 is the z axis.

The first end portions 411, 421, and 431 are formed as end portions of the arms of the vibration elements 41, 42, and 43, which can be vibrated. The first end portions 411, 421, and 431 receive Coriolis force having a size proportional to the angular velocity in a direction perpendicular to a direction of a natural vibration, by rotations of the first, second, and third vibration elements 41, 42, and 43 around the detection axes. The angular velocity sensor unit 40 detects vibrations by the Coriolis force, with the result that a degree of the angular velocity can be detected.

The second end portions 412, 422, and 432 are formed as base portions of the arms and are provided on a control substrate (not shown) or the like. Further, the angular velocity sensor unit 40 further includes, for example, a drive electrode (not shown) capable of causing natural vibrations for the first end portions 411, 421, and 431 and a detection electrode (not shown) that detects vibrations by the Coriolis force.

In this embodiment, the first, second, and third vibration elements 41, 42, and 43 are disposed so that first, second, and third straight lines L1, L2, and L3 extended in the extended directions (detection axis directions) are crossed at one point (point P). Further, angular velocity sensor unit 40 has the same distance d from the point P to the second end portion 421, to the second end portion 422, and to the second end portion 423. With this structure, it is possible to suppress variation in detection sensitivity of the vibration elements and detect the motion of the head portion with higher accuracy.

Further, in this embodiment, the second end portions 412, 422, and 432 are set to a position closer to the point P than the first end portions 411, 421, and 431. As a result, even in the case where the angular velocity sensor unit 40 is formed to be compact, it is possible to suppress an interference among the vibration elements 41, 42, and 43 due to a mechanical vibration, electrical connection, and the like.

The detection unit 4 outputs, to the controller 3, an electrical signal corresponding to the angular velocity as a detection signal by each of the vibration elements 41, 42, and 43. The electrical signal may be a voltage value, for example. Further, the detection signal in the case where the angular velocity is detected is output as an electrical vibration with a period and amplitude corresponding to the motion, for example.

It should be noted that, the detection unit 4 may include an integrated circuit (IC) (not shown) or the like that is provided on the same circuit substrate as the angular velocity sensor unit 40 and processes the detection signal. The IC performs predetermined processes such as A/D (Analog/Digital) conversion with respect to a signal output from the angular velocity sensor unit 40 and amplification. Thus, the detection signal easily processed by the controller 3 is supplied. Further, the IC may be provided separately from the detection unit 4. In this case, the IC can be provided in the vicinity of the detection unit 4 or in the same casing as the controller 3 as appropriate, for example.

(Controller)

The controller 3 can switch information presented by the presentation unit 2 (display unit 20) on the basis of the output from the detection unit 4. In this embodiment, the controller 3 includes an image control unit 30, an image obtaining unit 31, and a storage unit 32. The components of controller 3 are stored in one casing, for example. Hereinafter, a description will be given with reference to FIG. 2.

The image obtaining unit 31 can obtain predetermined image data to be presented to the user. In this embodiment, the image obtaining unit 31 has an input terminal (not shown) to which the image data is supplied and an image conversion circuit (not shown) that performs conversion or the like for a standard of the supplied image data. It should be noted that the image data that has been subjected to the image conversion or the like by the image obtaining unit 31 is also referred to as the “image data”.

The input terminal can be directly connected to an external apparatus in which image data is generated, such as an endoscopic apparatus, an ultrasonic apparatus, and a game machine. Alternatively, the input terminal may be connected with an external memory or the like that stores image data obtained in advance. Further, a plurality of input terminals with standards suitable for the connection with those apparatuses may be provided.

The image conversion circuit can convert the image data obtained into image data to be displayed from the HMD 1. For example, the image conversion circuit may have an up converter for converting the image data into image data with a standard suitable for the HMD 1. Alternatively, the image conversion circuit may be capable of restructuring the image data obtained, for example, may be capable of structuring 3D image data from 2D image data.

The image control unit 30 can switch the image data on the basis of a detection signal output from the detection unit 4. Specifically, the image control unit 30 determines whether a predetermined motion is performed by the user on the basis of the output from the detection unit 4, and switches the image data to be output into image data corresponding to the motion.

Specifically, the image control unit 30 determines the motion of the user on the basis of the detection signal output from each of the vibration elements 41, 42, and 43 of the detection unit 4. That is, the image control unit 30 determines whether the obtained detection signal satisfies a condition as a detection signal corresponding to a predetermined motion or not, thereby determining the motion of the user. As a specific determination method, for example, the determination can be performed on the basis of whether the amplitude of electrical vibrations of the output detection signal is a predetermined threshold value or more, whether a frequency of the electrical vibrations falls within a range corresponding to an expected motion, or the like.

In the case where the predetermined motion is detected, the image control unit 30 outputs image data corresponding to the motion. For example, when a first image is displayed, if a first motion is detected, the image is switched to a second image. If a second motion is detected, the image is switched to a third image.

Further, controller 3 may include an HMD image conversion unit 33 connected to the HMD 1. For example, the HMD image conversion unit 33 can convert the image data generated by the image control unit 30 or the like to a standard suitable for the HMD 1.

Typically, the storage unit 32 is formed of a RAM (Random Access Memory), a ROM (Read Only Memory), or another semiconductor memory, for example. The storage unit 32 stores programs used for various computations performed by the controller 3, control parameters corresponding to operations for image control, and the like. It should be noted that the storage unit 32 may be connected to the image obtaining unit 31. In this case, the storage unit 32 may be capable of storing the obtained image data and the like and supplying the image data to the image control unit 30.

The image data output from the controller 3 is output to the presentation unit 2 (display unit 20) of the HMD 1 via the cable 15, and an image corresponding to the image data is displayed from the display surface 13 of the HMD 1.

Subsequently, the operation of the controller structured as described above will be described.

(Operation of Controller)

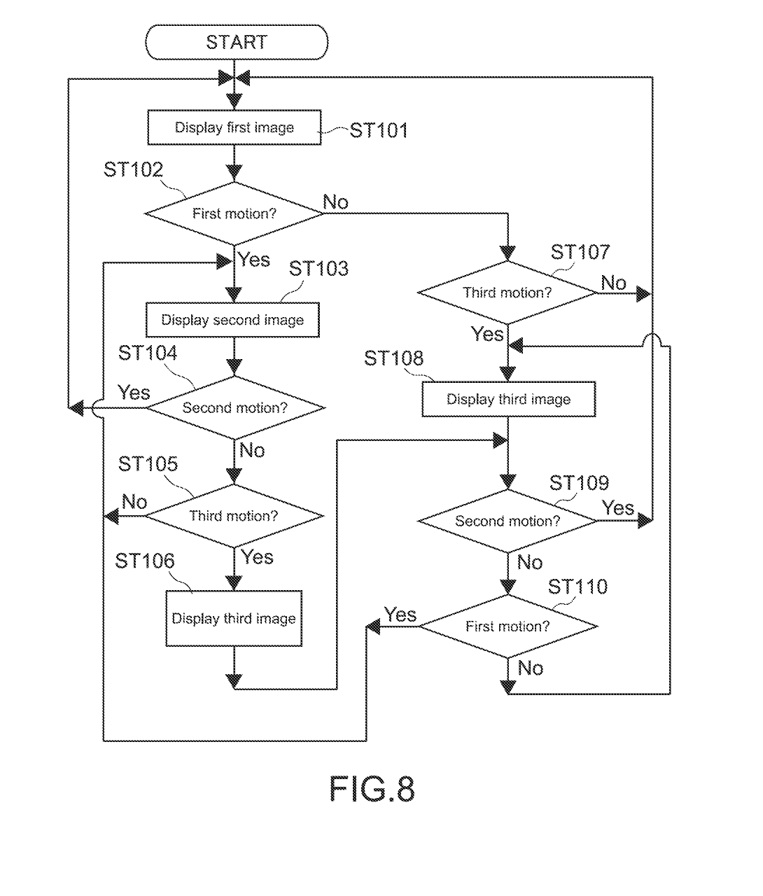

FIG. 8 is a flowchart for explaining an operation example of the controller 3. Here, a description will be given on an operation example in the case where the first image is controlled on the basis of the motion of the user when the first image is displayed on the HMD 1.

First, the controller 3 outputs a first image data obtained by the image obtaining unit 31 to the HMD 1 and causes the first image to be displayed (ST101).

On the other hand, the image control unit 30 of the controller 3 monitors the detection signals detected by the vibration elements 41, 42, and 43 of the detection unit 4 and determines whether a predetermined motion is performed or not. In this embodiment, the predetermined motion includes a first motion for switching the image data output from the image control unit 30 from the first image data or third image data to second image data, a second motion for switching the data from the second or third image data to the first image data, and a third motion for switching the data from the first or second image data to the third image data.

First, on the basis of the output from the detection unit 4, the image control unit 30 determines whether the first motion is performed or not (ST102). When it is determined that the first motion is performed (Yes in ST102), the image control unit 30 outputs the second image data switched from the first image data and causes a second image to be displayed on the HMD 1 (ST103). First, the first motion can be set as a motion of shaking the head up and down like nodding, for example.

The first motion can be grasped as a motion of pivoting the head portion about the X axis (x axis). In view of this, the image control unit 30 can determine that the first motion is performed when the amplitude of the detection signal from the vibration element 41 that detects the angular velocity around the x axis is equal to or more than a predetermined threshold value and when a frequency thereof is equal to or more than a predetermined value.

After the second image is displayed on the HMD 1, the image control unit 30 determines whether the second motion is performed or not (ST104). The second motion may be set as a motion of directing the face to right and left alternately, for example, but is not particularly limited thereto. The second motion can be grasped as a motion of pivoting the head portion about the Y axis (y axis). In view of this, the image control unit 30 can determine that the second motion is performed when the amplitude of the detection signal from the vibration element 42 that detects the angular velocity around the y axis is equal to or more than a predetermined threshold value and when the frequency thereof is equal to or more than a predetermined value.

When the image control unit 30 determines that the second motion is performed (Yes in ST104), the image control unit 30 outputs the first image data switched from the second image data and causes the first image on the HMD 1 again (ST101).

On the other hand, when the image control unit 30 determines that the second motion is not performed (No in ST104), the image control unit 30 determines whether the third motion is performed or not (ST105). The third motion may be set as a motion of tilting the head to a right side and a left side like cocking the head to the side, for example, but is not limited thereto. The third motion can be grasped as a motion of pivoting the head portion about the Z axis (z axis). In view of this, the image control unit 30 can determine that the third motion is performed when the amplitude of the detection signal from the vibration element 43 that detects the angular velocity around the z axis is equal to or more than a predetermined threshold value and when the frequency thereof is equal to or more than a predetermined value.

When the image control unit 30 determines that the third motion is performed (Yes in ST105), the image control unit 30 outputs the third image data switched from the second image data and causes the third image on the HMD 1 (ST106). After that, the process proceeds to ST109 in which the second motion is determined.

Further, when it is determined that the third motion is not performed (No in ST105), the image control unit 30 continuously outputs the second image data (ST103).

On the other hand, when it is determined that the first motion is not performed in ST102 (No in ST102), the image control unit 30 determines whether the third motion is performed or not (ST107). When it is determined that the third motion is performed (Yes in ST107), the image control unit 30 outputs the third image data switched from the first image data and causes the third image to be displayed on the HMD 1 (ST108). When it is determined that the third motion is not performed (No in ST107), the image control unit 30 continuously outputs the first image data (ST101).

After the third image is displayed on the HMD 1, the image control unit 30 determines whether the second motion is preformed or not (ST109). When it is determined that the second motion is performed (Yes in ST109), the image control unit 30 outputs the first image data switched from the third image data and causes the first image to be displayed on the HMD 1 (ST101).

On the other hand, the image control unit 30 determines that the second motion is not performed (No in ST109), the image control unit 30 determines whether the first motion is performed or not (ST110). When it is determined that the first motion is performed (Yes in ST110), the image control unit 30 outputs the second image data switched from the third image data and causes the second image to be displayed on the HMD 1 again (ST103). On the other hand, when it is determined that the first motion is not performed (No in ST110), the image control unit 30 continuously outputs the third image data (ST108).

As described above, according to this embodiment, it is possible to switch the images by the motion of the head portion of the user and achieve a smooth input operation without using a hand or a foot by the user. Here, in the case where the image switching is performed on the basis of the motion of the head portion, by controller 3, it is necessary to clearly perform on/off determination relating to whether the predetermined motion is performed or not. That is, a high-quality detection signal that allows the determination is demanded.

In view of this, according to this embodiment, by providing the detection unit 4 across the median plane of the user who wears the main body 10, the demand can be met. Hereinafter, the operation and effect of the HMD 1 (information processing system 100) will be described.

(Operation and Effect of HMD (Information Processing System))

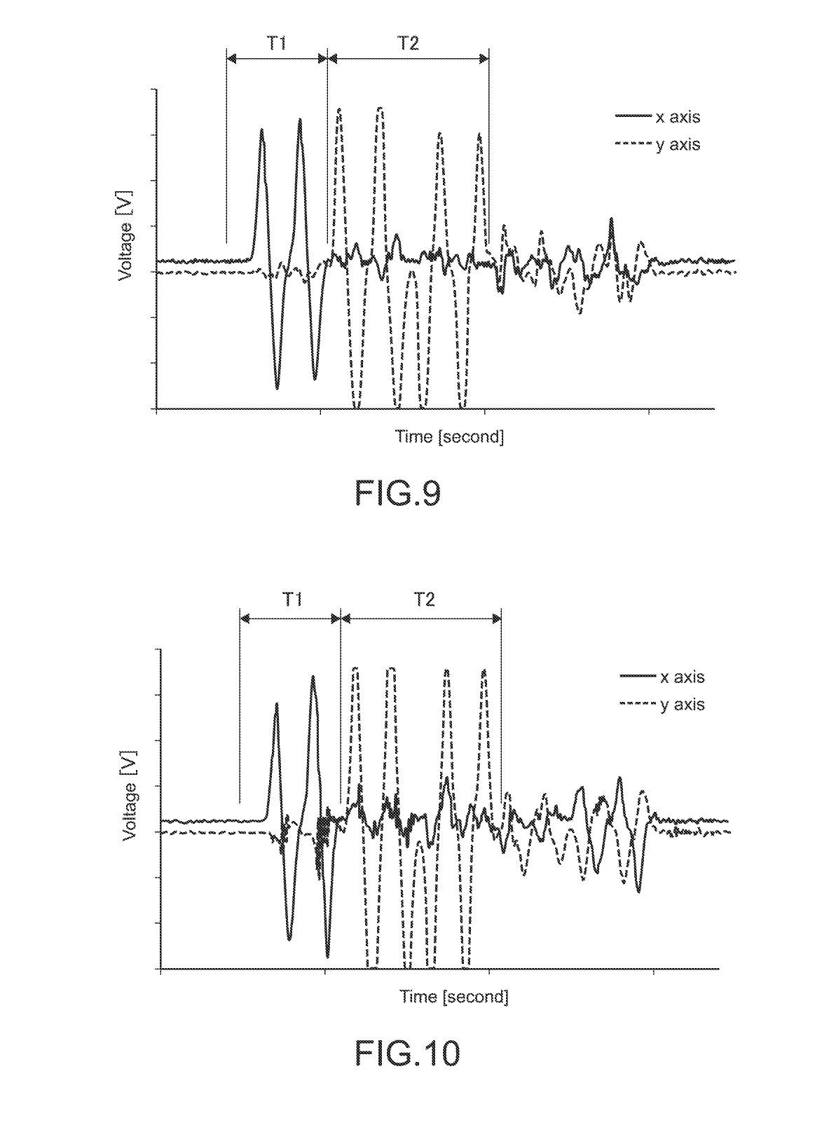

FIGS. 9 to 11 are graphs showing specific examples of the detection signals when the detection unit is disposed on different positions on the main body 10, in which the lateral axis represents time, and the vertical axis represents a voltage value. In the graphs shown in FIGS. 9 to 11, the detection signal output from the first vibration element that detects the angular velocity about the x axis is indicated by a solid line, and the detection signal output from the second vibration element that detects the angular velocity about the y axis is indicated by a broken line. Further, in the figures, T1 represents a time period during which the first motion (for example, motion of shaking the head up and down and up and down) is performed, and T2 in the figure represents a time period during which the second motion (for example, motion of directing the face to the left, the right, the left, the right, the left, and the right alternately) is performed. It should be noted that in the experiment shown in FIGS. 9 to 11, as the detection unit, a two-axis angular velocity sensor module having the first and second vibration elements is used.

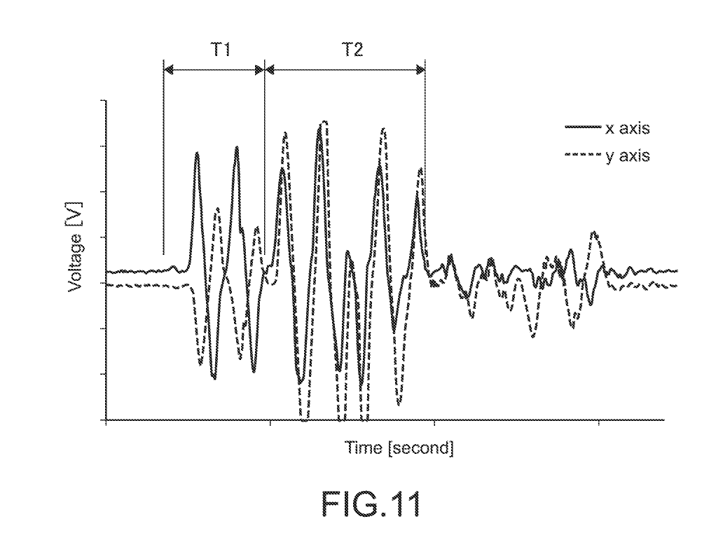

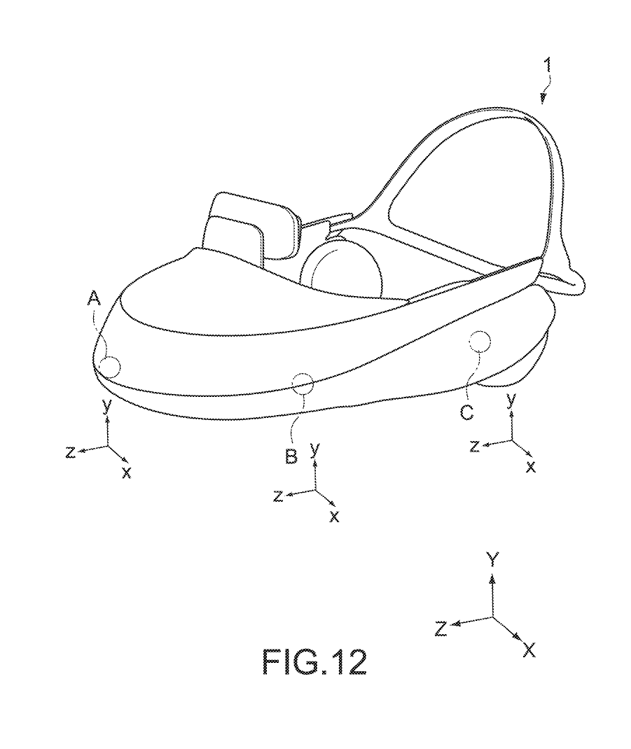

Further, FIG. 12 is a schematic perspective view of the HMD 1 showing the positions of the detection unit corresponding to FIGS. 9 to 11. A point A indicates a position of the detection unit at a time when a result shown in FIG. 9 is obtained. A point B indicates a position of the detection unit at a time when a result shown in FIG. 10 is obtained. A point C indicates a position of the detection unit at a time when a result shown in FIG. 11 is obtained. Further, the point A is disposed across the median plane of the user who wears the main body 10 and is opposed to the glabella portion of the user. On the other hand, the point B and the point C are not disposed across the median plane of the user. The point B is located in the vicinity of the corner of an eye of the user, and the point C is located in the vicinity of a temple of the user. It should be noted that x, y, and z axes shown in the vicinity of the point A, the point B, and the point C of FIG. 12 indicate an xyz coordinate system of the detection unit that is disposed the points.

First, with reference to FIG. 9, at the time of the first motion (T1), from the first vibration element that detects the angular velocity about the x axis, electrical vibrations with a frequency corresponding to the first motion and relatively large amplitude were detected. Here, a voltage value and the angular velocity approximately have a proportional relationship, so the electrical vibrations with the large amplitude indicate that a pivotal motion about the x axis at a relatively high speed was repeatedly detected. In contrast, from the output from the second vibration element that detects the angular velocity about the y axis, almost no variation from a reference voltage value was confirmed. That is, from the result in T1 shown in FIG. 9, two repetition motions with the pivotal motion about the x axis were detected, and the motion with the pivotal motion about the y axis was not detected.

On the other hand, at the time of the second motion (T2), from the second vibration element, electrical vibrations with a period corresponding to the second motion and large amplitude were detected. In contrast, from the output of the first vibration element, there was almost no variation from the reference voltage value. That is, from the result in T2 shown in FIG. 9, four reciprocation motions with the pivotal motion about the y axis were detected, and the motion with the pivotal motion about the x axis was not detected.

From the results shown in FIG. 9, in the case where the detection unit is disposed at the point A, it was confirmed that both of the first motion and the second motion can be detected with high accuracy. Further, so-called axis interference that at a time of a pivotal motion about one axis, the angular velocity about the other axis is detected was hardly confirmed, and noises were hardly generated.

Subsequently, with reference to FIG. 10, during the first motion (T1), from the first vibration element, electrical vibrations with a frequency corresponding to the first motion and with relatively large amplitude were detected. Also, from the output from the second vibration element, a small variation from the reference voltage value was confirmed. On the other hand, also at the time of the second motion (T2), from the second vibration element, electrical vibrations at a frequency corresponding to the second motion and with relatively large amplitude were detected. Also from the output from the second vibration element, a small variation from the reference voltage value was confirmed.

From the result shown in FIG. 10, in the case where the detection unit is disposed at the point B, it was confirmed that small axis interference was caused, and noise was generated.

Then, with reference to FIG. 11, at the time of the first motion (T1), from the first vibration element, electrical vibrations with a frequency corresponding to the first motion were detected. Also from the second vibration element, electrical vibrations with the same period were detected. Further, the amplitude of the electrical vibrations from the first vibration element was smaller than the amplitude shown in FIG. 9. That is, from the result in T1 shown in FIG. 11, two reciprocation motions with the pivotal motion about the x axis were barely detected, and the motion with the pivotal motion about the y axis was also detected.

Further, also at the time of the second motion (T2), not only from the second vibration element but also from the first vibration element, electrical vibrations with the frequency corresponding to the second motion and with approximately the same amplitude were detected. In this case, the output from the first vibration element was detected to be larger than the output of the second vibration element. That is, from the result in T2 shown in FIG. 11, with four reciprocation motions along with the pivotal motion about the y axis, the motion along with the pivotal motion about the x axis was detected.

From the result shown in FIG. 11, in the case where the detection unit is disposed at the point C, it was confirmed that the axis interference is caused, and a significantly large noise is generated. Thus, the result on which an actual motion of the head portion is reflected was not obtained.

From the results as described above, it was confirmed that, by disposing the detection unit 4 across the median plane of the user who wears the main body 10, the detection signal with less noise, on which the motion of the head portion is correctly reflected was obtained. It should be noted that, although not shown in the above results, in the case where the detection unit includes the third vibration elements capable of detecting the angular velocity about the z axis, and the user carries out the third motion with the pivotal motion about the Z axis, the same result was obtained.

Further, because the noise of the detection signal is less generated, it is possible to perform determination of the motion by the controller 3. For example, for the determination of the second motion, the fact that the amplitude of the detection signal from the second vibration element is equal to or more than a predetermined threshold value, and the amplitude of the detection signal from the first vibration element is less than a predetermined threshold value can be used as a reference. In this case, in the case where the large noise is generated as shown in FIG. 11, it is difficult to determine the second motion by using the reference described above. On the other hand, in the case where there is almost no noise as shown in FIG. 9, it is possible to reliably determine the second motion on the basis of the reference.

As described above, according to this embodiment, it was confirmed that it is possible to obtain the high-quality detection signals that allow the determination whether the motion of the head portion is performed or not to be clearly performed. Hereinafter, the above results will be studied.

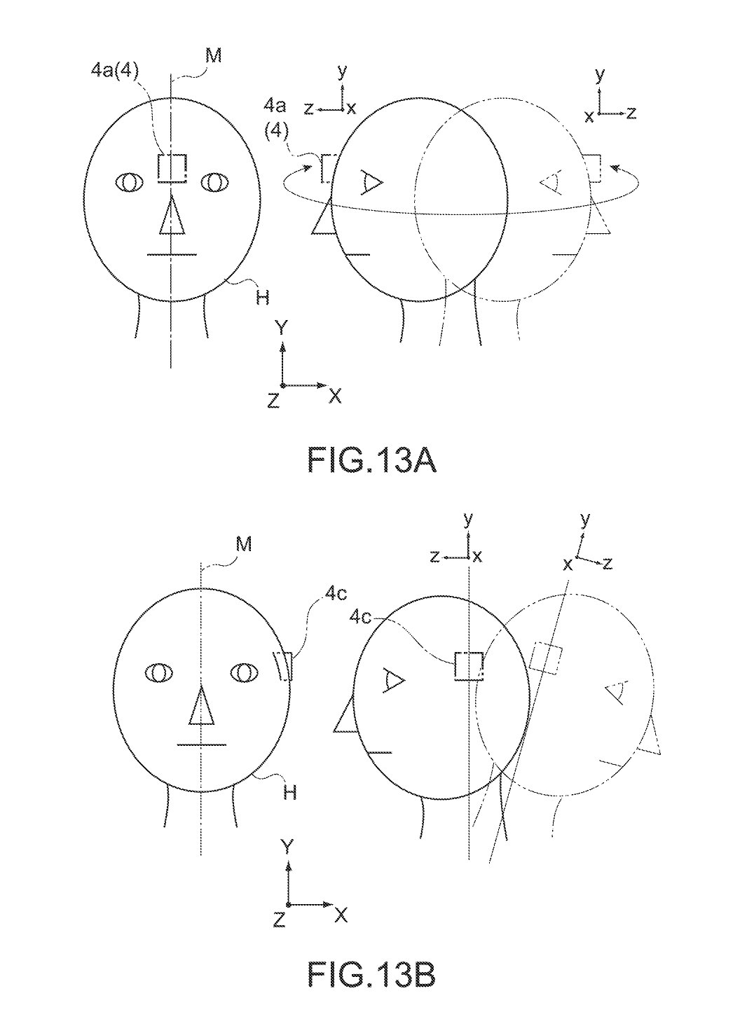

FIGS. 13A and 13B are schematic diagrams for explaining a relationship between the second motion of the user and the detection unit. FIG. 13A shows the case where a detection unit 4a (4) is disposed at the point A, and FIG. 13B shows the case where a detection unit 4c is disposed at the point C.

As shown in FIG. 13A, by the second motion, the head portion of the user is pivoted about a neck bilaterally symmetrically. At this time, the head portion is pivoted while twisting the neck, but the point A is not affected by the twisting and is shifted along an approximately bilaterally symmetric track like the center of gravity of the head portion. Thus, it is thought that detection unit 4a can maintain such a posture that, at the time of the motion of the head portion, the detection axes coincide with the X axis, the Y axis, and the Z axis to which the user belongs, and noise generation is suppressed.

On the other hand, as shown in FIG. 13B, by the second motion, the point C is shifted along a bilaterally asymmetric track, which is completely different from the center of gravity of the head portion. Along with this, it is thought that the point C is significantly affected by the twisting of the neck. As a result, it may be impossible for the detection unit 4c to maintain such a posture that the detection axes coincide with the X axis, the Y axis, and the Z axis, and it is thought that a crosstalk among axes arises, and a large noise is generated.

Further, the neck, as the center of the pivotal motion, is located not on the center part of the head portion but on a position closer to the back of the head. Therefore, at the time of the second motion, for the point A, a change in distance from the neck as the center of the pivotal motion is small, and the change has symmetry. In contrast, the point C is shifted asymmetrically, so the distance from the neck is significantly changed. This may also affect the noise generation at the point C.

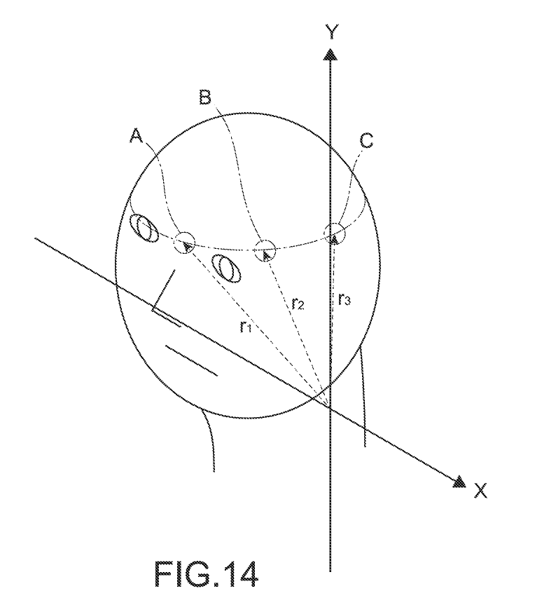

Further, FIG. 14 is a diagram for explaining the results described above from another viewpoint. The figure schematically shows distances r₁, r₂, and r₃ from the neck as the center of the pivotal motion of the head portion to the point A, the point B, and the point C, respectively. With reference to FIG. 14, the distances r₁, r₂, and r₃ have the following relationship.

r₁>r₂>r₃

For the point A, the distance from the center of the pivotal motion is the longest, so a velocity (circumferential velocity) on the XYZ coordinate system is increased in proportional to the distance from the center of the pivotal motion. As a result, it is thought that when the distance is longer in the case of the same angular velocity, the circumferential velocity becomes higher, and higher detection accuracy can be obtained.

As described above, according to this embodiment, it is possible to correctly determine the motion of the head portion of the user. Therefore, it is possible to perform the switching operation of the images or the like without using the hand, the foot, or the like by the user. As a result, unlike the case of providing an input operation unit to an HMD main body, it is possible to prevent an operation error due to groping to perform the operation. Further, it is possible to eliminate a troublesome task of detaching the HMD to perform the operation in order to prevent the operation error. Furthermore, there is no need to perform the input operation while viewing a lower part (outside) through a gap or the like between the casing 11 and the face of the user, so it is possible to provide a sense of immersion to the user who is viewing the image.

Further, in an endoscopic surgery or the like, hands and fingers are difficult to be used for hygienic reasons. Therefore, the image switching operation when the HMD is mounted is difficult in related art. According to this embodiment, even in such a situation that the input operation with a hand or the like, it is possible to perform a desired image switching operation.

As described above, according to this embodiment, it is possible to switch an images or the like smoothly and correctly in line with user's intention without giving stress to the user.

### Second Embodiment

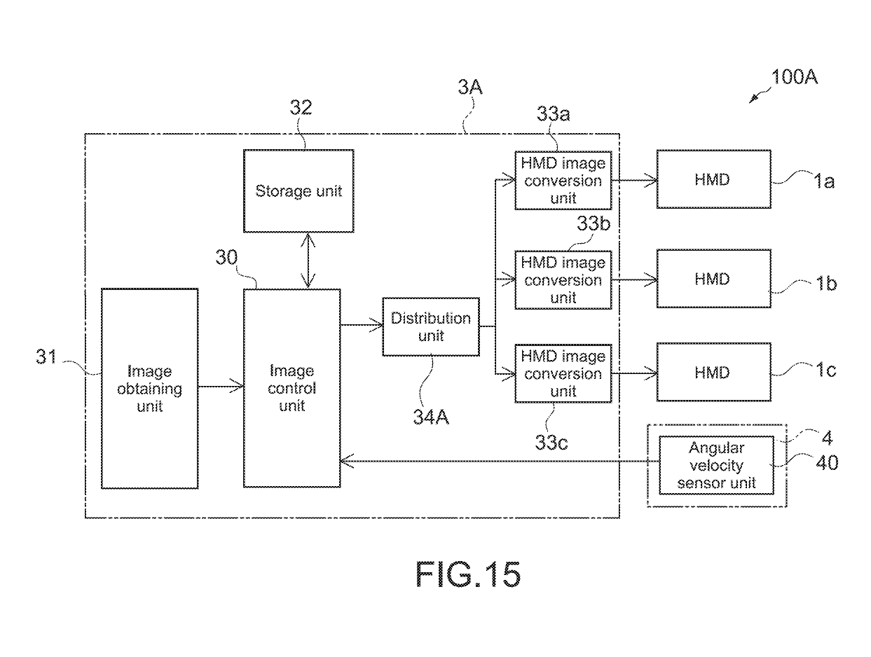

FIG. 15 is a block diagram showing the structure of an information processing system according to a second embodiment of the present technology. An information processing system 100A according to this embodiment is mainly different from the information processing system 100 according to the first embodiment in that the information processing system 100A includes a plurality of HMDs 1a, 1b, 1c, and a detection unit 4 is disposed on the HMD 1a.

The HMD 1a has substantially the same structure as the HMD 1 according to the first embodiment. That is, the HMD 1a includes the main body 10 mounted on a head portion of a user, the detection unit 4 that detects a motion of the head portion of the user, and the presentation unit 2 capable of presenting predetermined information to the user. Further, according to this embodiment, the HMDs 1b and 1c each include the main body 10 and the presentation unit 2 but do not include the detection unit 4. The HMDs 1a, 1b, and 1c have the same structure except for whether the detection unit 4 is provided or not, and are connected to a controller 3A, with a cable (not shown), for example. It should be noted that the structure of the HMDs 1a, 1b, and 1c are the same as that of the HMD 1 according to the first embodiment, so a detailed description thereof will be omitted.

Like the controller 3 according to the first embodiment, on the basis of an output from the detection unit 4 disposed on the HMD 1a, the controller 3A can switch the information presented by the presentation unit 2. The controller 3A includes, in this embodiment, the image control unit 30, the image obtaining unit 31, the storage unit 32, a distribution unit 34A, and HMD image conversion units 33a, 33b, and 33c. In this embodiment, the image control unit 30, the image obtaining unit 31, and the storage unit 32 have the same structures as those in the first embodiment, so the distribution unit 34A and the HMD image conversion units 33a, 33b, and 33c will be described.

The distribution unit 34A distributes image data output from the image control unit 30 at approximately the same level and outputs the data to the HMDs 1a, 1b, and 1c. As a result, the controller 3A can display the same image on each of the HMDs 1a, 1b, and 1c.

Like the HMD image conversion unit 33 according to the first embodiment, the HMD image conversion units 33a, 33b, and 33c can convert the image data generated by the image control unit 30 or the like to a standard in conformity to the HMDs 1a, 1b, and 1c, for example.

As described above, in this embodiment, in addition to the same operation and effect as the first embodiment, it is possible to switch the images presented to all the users who wear the HMDs 1a, 1b, and 1c on the basis of the motion of the head portion of the user who wears the HMD 1a on which the detection unit 4 is disposed. As a result, it is possible to allow the users who wear the HMDs 1a, 1b, and 1c to smoothly execute a task even in a situation in which information has to be shared by all the users.

### Third Embodiment

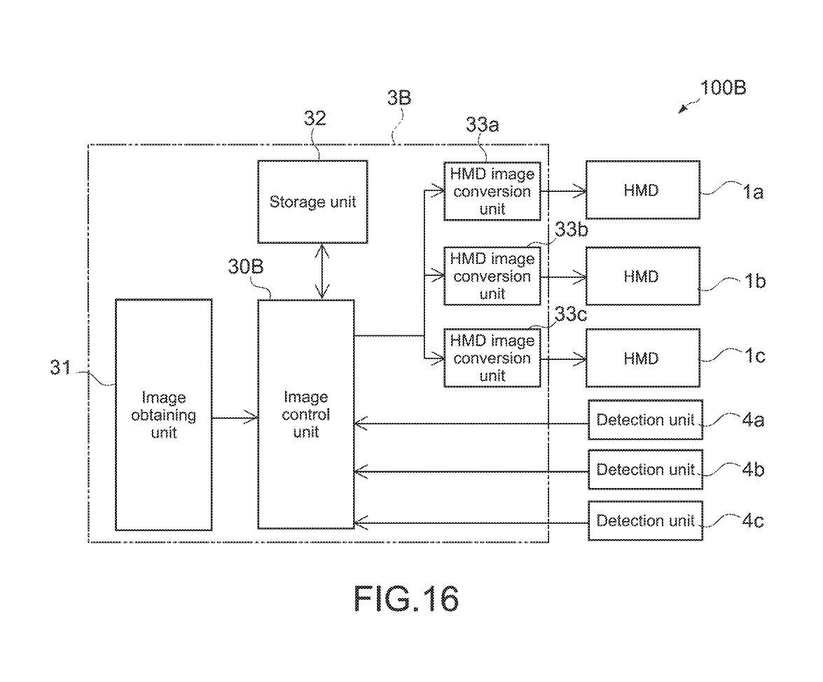

FIG. 16 is a block diagram showing the structure of an information processing system according to a third embodiment of the present technology. An information processing system 100B according to this embodiment is mainly different from the information processing systems 100 and 100A according to the first and second embodiments, respectively, in that the information processing system 100B includes the HMDs 1a, 1b, and 1c and a plurality of detection units 4a, 4b, and 4c, and the detection units 4a, 4b, and 4c are disposed on the HMDs 1a, 1b, and 1c, respectively.

The HMDs 1a, 1b, and 1c have substantially the same structure as the HMD 1 according to the first embodiment. That is, the HMDs 1a, 1b, and 1c each includes the main body 10 mounted on the head portion of the user, the presentation unit 2 capable of presenting predetermined information to the user, and the detection units 4a, 4b, and 4c that detect a motion of the head portion of the user. The HMDs 1a, 1b, and 1c according to this embodiment are connected to a controller 3B with a cable (not shown), for example. It should be noted that the HMDs 1a, 1b, and 1c according to this embodiment have the same structure as the HMD 1 according to the first embodiment, so a detailed description thereof will be omitted.

Like the detection unit 4 according to the first embodiment, the detection units 4a, 4b, and 4c are disposed on a position intersecting the median plane of each user who wears the main body 10 and are capable of detecting the motion of the head portion of the user. The detection units 4a, 4b, and 4c each include the angular velocity sensor unit 40. A detection signal output from the angular velocity sensor unit 40 is output to the image control unit 30B of the controller 3B. It should be noted that the angular velocity sensor unit 40 included in the detection units 4a, 4b, and 4c have the same structure as the angular velocity sensor unit 40 according to the first embodiment and is therefore not shown in FIG. 16.

Like the controller 3 according to the first embodiment, on the basis of outputs from the detection units 4a, 4b, and 4c disposed on the HMDs 1a, 1b, and 1c, respectively, controller 30B can switch the information presented by the presentation unit 2. The controller 3B includes, in this embodiment, an image control unit 30B, the image obtaining unit 31, the storage unit 32, and the HMD image conversion units 33a, 33b, and 33c. In this embodiment, the image obtaining unit 31, the storage unit 32, and the HMD image conversion units 33a, 33b, and 33c have the same structure as those in the first and second embodiments, so the image control unit 30B will be described.

On the basis of outputs from the detection units 4a, 4b, and 4c, the image control unit 30B detects motions of the users who wear the HMDs 1a, 1b, and 1c. Further, on the basis of the outputs from the detection units 4a, 4b, and 4c, the image control unit 30B switches image data displayed on each of the HMDs 1a, 1b, and 1c and outputs the image data to the HMD image conversion units 33a, 33b, and 33c. As a result, the image switched by the motion of the user who wears the HMD 1a is displayed on the HMD 1a, the image switched by the motion of the user who wears the HMD 1b is displayed on the HMD 1b, and the image switched by the motion of the user who wears the HMD 1c is displayed on the HMD 1c.

According to this embodiment, in addition to the same operation and effect as the first embodiment, the users who wear the HMDs 1a, 1b, and 1c can switch the images displayed on the HMDs 1a, 1b, and 1c on the basis of the motions of the users. As a result, for example, even in a situation in which tasks can be shared in an endoscopic surgery or the like, the efficiency of the tasks can be achieved. Alternatively, for example, it is possible to deal with a situation in which the users perform different input operations in a competition type game or the like.

In the above, the embodiments of the present technology are described, but the present technology is not limited to those and can be variously modified on the basis of the technical idea of the present technology.

For example, in the above embodiments, the presentation unit has the display unit but may have another unit. For example, the presentation unit may have a speaker unit capable of outputting voice switched on the basis of the output from the detection unit to the user. Specifically, the speaker unit can be a headphone 16 shown in FIG. 4, for example. With this structure, on the basis of the motion of the user, it is possible to switch the voice output to the user with high accuracy.

In addition, the presentation unit may include the display unit and the speaker unit and may be capable of presenting the image and the voice switched on the basis of the output from the detection unit to the user. With this structure, it is possible to switch both of the image and the voice without limiting to the switching of only the image or the voice.

Further, the information presentation apparatus is not limited to the HMD. For example, in the case where the presentation unit has the speaker unit, the information presentation apparatus itself may be a headphone apparatus. Furthermore, the structure of the information presentation apparatus is not particularly limited and may not have a symmetrical configuration.

In addition, in the above embodiments, the detection unit is disposed on the main body of the HMD but may be disposed on the head portion of the user by using another mounting tool different from the information presentation apparatus, for example.

Further, in the above embodiments, the detection unit is disposed so as to be opposed to the glabella portion of the user, but the position thereof is not limited to this as long as the detection unit is disposed on a position intersecting the median plane of the user who wears the main body. For example, the detection unit may be disposed on the vertex portion of the user or the occipital portion of the user. With this structure, it is also possible to suppress a noise of the detection signal output from the detection unit and detect the motion of the head portion of the user with high accuracy.

Further, as described above, the angular velocity sensor unit of the detection unit includes the gyro sensor of the vibration type but is not limited thereto. As the angular velocity sensor unit, a spinning-top gyro sensor, a ring laser gyro sensor, a gas rate gyro sensor, or the like can be selected as appropriate. Further, in the gyro sensor of the vibration type, the number of vibration elements may be one or two, and the disposition orientation is not limited to the perpendicular direction. Of course, the structure of the vibration element is not limited to the tuning fork type.

As an example, the angular velocity sensor unit of the detection unit may include a detection body capable of detecting angular velocities about three axes different from one another. Typically, in such a detection body, a main body of the detection body is provided with a plurality of vibrator units that vibrate in different directions. The detection body detects Coriolis force that acts on those vibrator units. By applying such an angular velocity sensor unit, it is possible to dispose the detection unit in an smaller space. Therefore, it is easy to dispose the detection unit on a desired position, for example, on the position opposed to the glabella portion. It should be noted that the structure of the detection body is not particularly limited, as long as one structure can detect the angular velocities about three axes.

Further, the structure of the detection unit is not limited to the structure including the angular velocity sensor unit. The structure that can detect a motion of a head portion of a user can be applied. For example, the detection unit may include an acceleration sensor unit. With this structure, the detection unit can detect an acceleration based on a motion of a head portion and detect the motion of the head portion of the user with high accuracy. In this case, the acceleration sensor unit may have such a structure as to detect one or two axes or three axes. As the acceleration sensor, for example, an acceleration sensor of a piezoresistance type, a piezoelectric type, a capacitance type, or the like can be used, although the sensor is not particularly limited.

Further, the detection unit may include the angular velocity sensor and the acceleration sensor unit. With this structure, for example, it is possible to form a six-axis motion sensor, with the result that it is possible to detect more complicated motions of a head portion with high accuracy.

Furthermore, in the above description, the first axis direction (x-axis direction) is the lateral direction but is not limited thereto. The first axis direction may be a vertical direction, for example. Further, the first, second, and third axis directions are not limited to the directions perpendicular to one another but may be directions intersecting one another.

It should be noted that the present disclosure can take the following configurations.

(1) An information presentation apparatus, including:

a main body mounted on a head portion of a user;

a detection unit disposed on a position intersecting a median plane of the user who wears the main body and configured to detect a motion of the head portion of the user; and

a presentation unit disposed on the main body and capable of presenting information switched on the basis of an output from the detection unit to the user.

(2) The information presentation apparatus according to Item (1), in which

the detection unit is disposed to be opposed to a glabella portion of the user who wears the main body in a direction perpendicular to the glabella portion.

(3) The information presentation apparatus according to Item (1) or (2), in which

the presentation unit includes a display unit capable of displaying an image switched on the basis of the output from the detection unit in front of eyes of the user.

(4) The information presentation apparatus according to Item (1) or (2), in which

the presentation unit includes a speaker unit capable of outputting voice switched on the basis of the output from the detection unit to the user.

(5) The information presentation apparatus according to any one of Items (1) to (4), in which

the detection unit includes an angular velocity sensor unit that detects the motion of the head portion of the user.

(6) The information presentation apparatus according to Item (5), in which

the angular velocity sensor unit includes

a first vibration element that detects an angular velocity about a first axis based on a first motion of the user, and

a second vibration element that detects an angular velocity about a second axis based on a second motion of the user, the second axis being different from the first axis.

(7) The information presentation apparatus according to Item (6), in which

a direction of the first axis is one of a lateral direction and a vertical direction.

(8) The information presentation apparatus according to Item (6) or (7), in which

a direction of the first axis and a direction of the second axis are perpendicular to each other.

(9) The information presentation apparatus according to Item (8), in which

the first and second vibration elements each have a first end portion capable of vibrating and a second end portion opposite to the first end portion and are extended along the directions of the first and second axes, respectively, and

in the angular velocity sensor unit, a distance from a point at which a first straight line and a second straight line intersect to the second end portion of the first vibration element is equal to a distance from the point to the second end portion of the second vibration element, the first straight line being extended along the direction of the first axis from the first vibration element, the second straight line being extended along the direction of the second axis from the second vibration element.

(10) The information presentation apparatus according to Item (5), in which

the angular velocity sensor unit includes a detection body capable of detecting angular velocities about three axes different from one another.

(11) An information processing system, including:

a main body mounted on a head portion of a user;

a presentation unit disposed on the main body and capable of presenting predetermined information to the user;

a detection unit disposed on a position intersecting a median plane of the user who wears the main body and configured to detect a motion of the head portion of the user; and

a control unit configured to switch the information presented by the presentation unit on the basis of an output from the detection unit.

It should be understood by those skilled in the art that various modifications, combinations, sub-combinations and alterations may occur depending on design requirements and other factors insofar as they are within the scope of the appended claims or the equivalents thereof.

What is claimed is:

1. An information presentation apparatus, comprising:
a main body mounted on a head portion of a user;
a detection unit disposed on a position intersecting a median plane of the user who wears the main body and configured to detect a motion of the head portion of the user; and
a presentation unit disposed on the main body and capable of presenting information switched on the basis of an output from the detection unit to the user.

2. The information presentation apparatus according to claim 1, wherein
the detection unit is disposed to be opposed to a glabella portion of the user who wears the main body in a direction perpendicular to the glabella portion.

3. The information presentation apparatus according to claim 1, wherein
the presentation unit includes a display unit capable of displaying an image switched on the basis of the output from the detection unit in front of eyes of the user.

4. The information presentation apparatus according to claim 2, wherein
the presentation unit includes a speaker unit capable of outputting voice switched on the basis of the output from the detection unit to the user.

5. The information presentation apparatus according to claim 1, wherein
the detection unit includes an angular velocity sensor unit that detects the motion of the head portion of the user.

6. The information presentation apparatus according to claim 5, wherein
the angular velocity sensor unit includes
a first vibration element that detects an angular velocity about a first axis based on a first motion of the user, and
a second vibration element that detects an angular velocity about a second axis based on a second motion of the user, the second axis being different from the first axis.

7. The information presentation apparatus according to claim 6, wherein
a direction of the first axis is one of a lateral direction and a vertical direction.

8. The information presentation apparatus according to claim 6, wherein
a direction of the first axis and a direction of the second axis are perpendicular to each other.

9. The information presentation apparatus according to claim 8, wherein
the first and second vibration elements each have a first end portion capable of vibrating and a second end portion opposite to the first end portion and are extended along the directions of the first and second axes, respectively, and
in the angular velocity sensor unit, a distance from a point at which a first straight line and a second straight line intersect to the second end portion of the first vibration element is equal to a distance from the point to the second end portion of the second vibration element, the first straight line being extended along the direction of the first axis from the first vibration element, the second straight line being extended along the direction of the second axis from the second vibration element.

10. The information presentation apparatus according to claim 5, wherein
the angular velocity sensor unit includes a detection body capable of detecting angular velocities about three axes different from one another.

11. An information processing system, comprising:
a main body mounted on a head portion of a user;
a presentation unit disposed on the main body and capable of presenting predetermined information to the user;
a detection unit disposed on a position intersecting a median plane of the user who wears the main body and configured to detect a motion of the head portion of the user; and
a control unit configured to switch the information presented by the presentation unit on the basis of an output from the detection unit.
